(19) United States
(12) Patent Application Publication
(10) Pub. No.: US 2010/0202780 A1
(43) Pub. Date: Aug. 12, 2010

(54) DIGITAL TRANSMISSION OF DATA IN WHITE LIGHT BY LEDS

(75) Inventor: Patrick Tortelier, Clichy (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/675,216

(22) PCT Filed: Sep. 12, 2008
(86) PCT No.: PCT/FR08/51642

§ 371 Date: Feb. 25, 2010

(30) Foreign Application Priority Data
Sep. 14, 2007 (FR) 0757572

(51) Int. Cl. H04B 10/00

(52) U.S. Cl. 398/118

(57) ABSTRACT

A device emits bit sequences (SB₁-SB₃) from a plurality of light sources (SL₁-SL₃) that emit radiation combined into substantially white light. Each light source has a different signal-to-noise ratio depending on the wavelength of the emitted radiation. The device includes a coder (COD) for coding the bit sequence (SB₃) to be emitted by the light source (SL₃) having the lowest signal-to-noise ratio by a code (CB₃) having a minimum distance the product of which by the lowest signal-to-noise ratio is substantially equal to the highest signal-to-noise ratio. The minimum distance of the code is equal to the minimum number of bits that differ between two words of the code. The bit error rate of the source emitting the coded sequence is reduced and the bit error rates of the various light sources are homogenized.

The present invention relates to a scheme for transmitting digital data for wireless optical communication.

It relates more particularly to error-correcting coding that operates on the digital data to be transmitted by a light source, also used as a source of illumination, to transmit signals in the downlink direction.

There are prior art light sources used both for illumination and to transmit data. Such a light source is generally a light-emitting diode (LED), which comprises an electronic component adapted to emit light when an electrical current is passed through it. A forward-biased P-N junction of the LED then emits monochromatic radiation. An LED can emit visible, infrared or ultraviolet radiation. Below, and by way of example, an LED emitting blue light, i.e. radiation at a wavelength in the visible spectrum that corresponds to the color blue is called a blue diode.

To be used as a source of illumination, for example in place of an incandescent bulb, an LED must emit white light. There are two ways for one or more LEDs to emit white light.

A first way is for a blue diode to emit radiation through a layer of fluorescent material that emits yellow light when it is excited by the blue light from the diode. The mixing of the colors of the radiation from the diode and from the layer of fluorescent material creates almost white light. The bit rate for transmission of data using such a diode is limited by the slow response time of the excitation of the fluorescent layer to emit the yellow light.

A second way is for light of different primary colors to be emitted by three respective LEDs that are sufficiently close for the different primary colors to mix to white light. For example, red, green, and blue diodes are combined to emit white light and form what is referred to as a “multi-chip white LED”. The signals emitted by each of the three diodes are modulated with the same data to effect optical digital transmission in white light.

For each different primary color diode, the signal received has a different signal-to-noise ratio and consequently a different bit error rate. For example, for a given position of the diodes relative to a photoreceiver and for a mean power of −30 dBm received by the photoreceiver, the bit error rates are respectively 1.8×10⁻², 1.7×10⁻³, and 4.2×10⁻⁶ for the red, green and blue diodes.

When one of the three bit error rates is much higher than the other two, like that for the red diode here, the error rate of the data signal resulting from the combined emissions of the three diodes depends to a very great extent on the highest error rate. This form of data transmission therefore does not obtain the benefit of the low bit error rate of the blue diode, for example. A detector responsive only to blue light is generally used to receive such a signal because blue light has the best signal-to-noise ratio.

To remedy the drawbacks referred to above, a method of the invention for emitting respective bit sequences from at least two light sources that emit radiation combined into substantially white light and that have different signal-to-noise ratios depending on the respective wavelengths of the radiation;

is characterized in that it includes coding the bit sequence to be emitted by the light source having the lowest signal-to-noise ratio by a code having a minimum distance the product of which by the lowest signal-to-noise ratio is substantially equal to the highest signal-to-noise ratio, the minimum distance of the code being equal to the minimum number of bits that differ between two words of the code.

Thus according to the invention at least one of the bit sequences is advantageously coded in order to reduce the bit error rate of the light source emitting the coded bit sequence. Consequently, the average of the bit error rates of the various light sources is also reduced.

According to another feature of the invention, the method can further include coding at least one other bit sequence to be emitted by a light source having another signal-to-noise ratio between the lowest signal-to-noise ratio and the highest signal-to-noise ratio inclusive by another code. This other code has a minimum distance the product of which by said other signal-to-noise ratio is substantially equal to the highest signal-to-noise ratio.

Thus the invention homogenizes the bit error rates of the various light sources in order to benefit from a low overall bit error rate that is close to the bit error rate produced by the light source having the highest signal-to-noise ratio.

The invention also relates to a device for emitting respective bit sequences from at least two light sources that emit radiation combined into substantially white light and that have different signal-to-noise ratios depending on the respective wavelengths of the radiation. The device is characterized in that it includes means for coding the bit sequence to be emitted by the light source having the lowest signal-to-noise ratio by a code having a minimum distance the product of which by the lowest signal-to-noise ratio is substantially equal to the highest signal-to-noise ratio, the minimum distance of the code being equal to the minimum number of bits that differ between two words of the code.

According to other features of the invention, the light sources can be light-emitting diodes. The device can include three light sources respectively adapted to emit substantially blue, green, and red light, which are primary colors that can be combined to produce substantially white light.

The invention further relates to a computer program adapted to be executed in a device for emitting respective bit sequences from at least two light sources that emit radiation combined into substantially white light and that have different signal-to-noise ratios depending on the respective wavelengths of the radiation. The program includes instructions which, when the program is executed in said device, code the bit sequence in accordance with the method of the invention.

Other features and advantages of the present invention become more clearly apparent on reading the following description of several embodiments of the invention provided by way of non-limiting example and with reference to the corresponding appended drawings, in which:

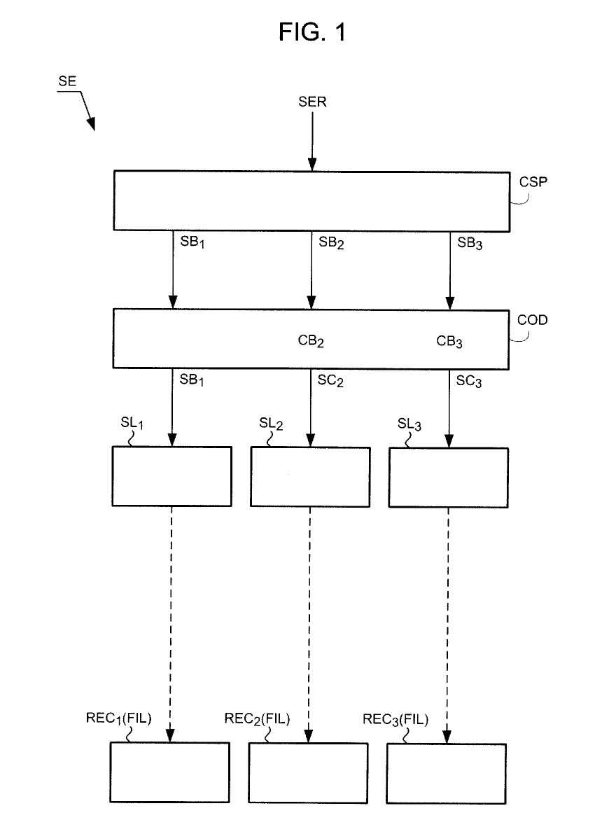

FIG. 1 is a block schematic of a device of the invention for emitting white light; and

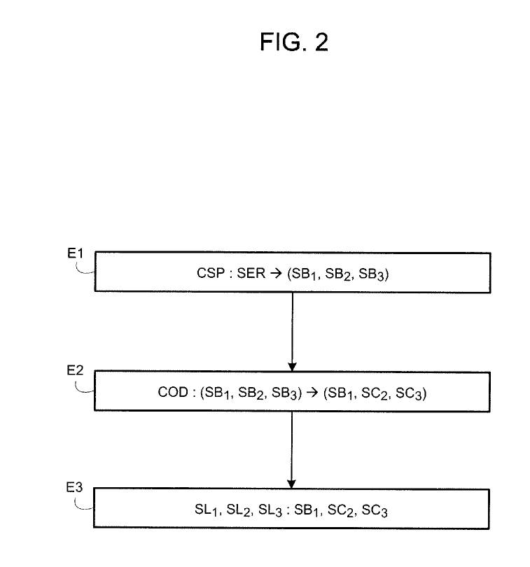

FIG. 2 represents an algorithm of a method of the invention for emitting signals using white light.

Referring to FIG. 1, a device SE of the invention for emitting white light comprises at least two light sources disposed close to each other and emitting radiation of different colors, i.e. emitting light waves with different wavelengths in the visible spectrum, so that combining the radiation emitted by the light sources produces substantially white light.

Generally speaking, the emission device SE comprises K light sources SLₖ, where 1≦k≦K and K≧2. In order not to overcomplicate FIG. 1, only three light sources SL₁, SL₂, and SL₃ are shown.

A light source SLₖ serves as a photo-emitter for optical data transmission and also as a source of illumination.

For example, the emission device SE covers a relatively small space, such as a closed room inside an office building or inside a private house or apartment.

For example, the emission device SE is used to broadcast data at a high bit rate, such as digital video data. The emission device SE can be connected to a computer in which a video file is stored. The video file is then broadcast via the emission device and received by a photoreceiver adapted to receive optical transmissions. Another computer connected to the photoreceiver can then play back the video file broadcast in this way. Generally speaking, the emission device can be used to set up a wireless network between information technology entities situated in the same room, at the same time as illuminating the room.

The light waves used for optical transmission have a wavelength of the order of a few hundred nanometers and are partly absorbed and reflected by obstacles in the room and by the walls of the room. Consequently, two emission devices used in two different closed rooms cannot interfere with each other. Moreover, a photoreceiver can receive waves emitted by the emission device SE and reflected from the walls of the room, and so the emission device can cover a very large volume of the room.

A light source SLₖ is a light-emitting diode, for example, which emits monochromatic radiation from a P-N junction at one or more given wavelengths depending on the nature of the material constituting the P-N junction.

In one embodiment of the invention, the emission device SE comprises three light sources SL₁, SL₂, and SL₃ that are LEDs emitting light of different primary colors. For example, the three light sources SL₁, SL₂, and SL₃ are LEDs respectively emitting blue, green, and red light, so that combining the light emitted by the diodes produces substantially white light.

Each light source SLₖ, where 1≦k≦K, emits substantially monochromatic radiation at a given wavelength and is associated with a photoreceiver RECₖ adapted to receive and to analyze the emitted radiation. For example, the photoreceiver RECₖ comprises a photodetector such as a photodiode that converts incident light into an electrical signal. The photoreceiver comprises a reverse-biased P-N junction that absorbs the radiation waves emitted by the source SLₖ and generates an electrical current the amplitude of which is proportional to the incident optical power of the received radiation.

Each photoreceiver RECₖ can be equipped with a filter FIL to concentrate and filter the received radiation. This filter selects the wavelength or wavelengths transporting useful data and eliminates unwanted radiation emitted by other light sources, thus reducing the noise introduced by those other light sources. For example, the filter FIL comprises a hemispherical lens centered on the photodiode to increase the angle of incidence of the received radiation relative to the central axis of the photosensitive face of the photodiode.

In particular, the electric current of magnitude I generated by the photoreceiver RECₖ is proportional to the optical power PO received by the photoreceiver:

I=R×PO

where R is a factor of proportionality.

The signal-to-noise ratio SNRₖ in the photoreceiver RECₖ is then given by the following equation, in which σ² is the variance of the noise:

SNRₖ=(R×PO)²/σ²

Each photoreceiver RECₖ is sensitive to a signal-to-noise ratio SNRₖ that depends on the associated light source SLₖ. Each light source SLₖ has a different signal-to-noise ratio SNRₖ that depends on the wavelength of the light it emits. In the example with three light sources SL₁, SL₂, and SL₃ respectively emitting blue, green, and red light, the light source SL₁ emitting blue light has a higher signal-to-noise ratio SNR₁ than the other light sources SL₂ and SL₃.

Thus a digital signal can be sent in the form of light wave radiation from a light source SLₖ to a photoreceiver RECₖ using an intensity modulation/direct detection (IM/DD) process. On receiving the radiation, the photoreceiver RECₖ produces an electric current proportional to the incident optical power, i.e. effects direct detection, and the light source SLₖ emits a digital signal in the form of light waves that is intensity modulated by the binary data of the signal.

For example, the light source SLₖ emits an intensity-modulated digital signal X(t) comprising M bits in accordance with the following equation:

$$X ( t ) = {\sum }_{m = 1}^{M} {d}_{m} p ( t - mt )$$

where p(t)=Rect(t) is a rectangular pulse of width T and dₘ is the m^{th} bit of the signal, either a “0” or a “1”. This intensity modulation is of the on-off keying (OOK) type and modulates a substantially monochromatic carrier wave directly using the binary signal, i.e. it emits a light pulse only for “1” bits and emits no pulse for “0” bits. This form of modulation consumes little energy and is of low complexity. The photoreceiver effects direct detection bit by bit. In the photoreceiver, zero optical power is received for a “0” bit and the optical power received for a “1” bit is equal to twice the average optical power received.

The emission device SE processes a series SER of bits that are distributed between and emitted in parallel by the K light sources SL₁ to SL_{K}.

In the emission device SE, a serial-parallel converter CSP converts this series SER of bits into K bit sequences SB₁ to SB_{K} that are distributed between K respective parallel emission channels ending at the light sources SL₁ to SL_{K}. The emission device SE includes a coder COD that transforms a sequence SBₖ of bits into a respective sequence of coded bits SCₖ that is then emitted by the respective light source SLₖ. Each coded bit sequence SCₖ can be coded differently from the others. Moreover, at least one bit sequence is not coded. The bit sequence that is not coded is that emitted by the light source that has the highest signal-to-noise ratio of the various light sources. In the example with three light sources SL₁, SL₂, and SL₃ that are respectively blue, green, and red diodes, the bit sequence SB₁ is not coded.

A few terms and concepts useful for understanding the invention are defined below.

A bit sequence SBₖ can be coded into a coded bit sequence SCₖ by a binary code CB of length n containing l payload information bits, where l<n, with a minimum distance d. The minimum distance is equal to the minimum number of bits that differ between two words of the code CB. A code has a high error-correcting capacity if the minimum distance is large.

The Hamming weight is defined by the number of non-zero bits in a code word.

In a Hamming weight enumerator polynomial P(X) each coefficient pᵢ of the respective mononomial Xⁱ is equal to the number of code words with a Hamming weight equal to i:

$$P ( X ) = {\sum }_{i = 0}^{n} {p}_{i} {X}^{i}$$

where n, the length of the code, is also the maximum Hamming weight of the code.

A first weight enumerator polynomial A(X,z), or input output weight enumerator function (IOWEF), is defined as follows:

$$A ( X , z ) = {\sum }_{i = 0}^{n} {\sum }_{j = 0}^{1} {A}_{i , j} {z}^{j} {X}^{i}$$

where A_{i,j} is the number of words with a Hamming weight equal to i and having j non-zero payload information bits, Xⁱ is a mononomial associated with the Hamming weight i, and z^{j} is a mononomial associated with the number j of non-zero bits. The coefficients A_{i,j} are zero for 0<i<d by virtue of the definition of the minimum code distance. The index j takes values between 1 and l because the index j indicates how many information bits differ between two code words of length n and dimension l, this dimension being the number of information bits in the code words.

A second weight enumerator polynomial B(X) is defined as follows:

$$B ( X ) = {\sum }_{i = 1}^{n} {B}_{i} {X}^{i}$$

where B₁ is defined by the following equation:

$${B}_{i} = {\sum }_{j = 1}^{1} j {A}_{i , j}$$

In a first example, the binary code CB is a Bose-Chaudhuri-Hocquenghem (BCH) code of length n=31, containing l=21 payload information bits and having a minimum distance d=5. First terms of the first and second enumerator polynomials of the BCH code are: A(X, z)=1+X⁵(5z+29z²+63z³+67z⁴+22z⁵)+X⁶(3z+57z²+173z³+279z⁴+240z⁵+54z⁶)+ . . . , and B(X)=630 X⁵+3276 X⁶+ . . . .

The term 29 z² X⁵ for the first polynomial A(X,z) signifies that the BCH code has A_{5,2}=29 code words with a Hamming weight equal to i=5 and having j=2 non-zero payload information bits.

In a second example, the binary code CB is a Golay code of length n=24 containing l=12 payload information bits and having a minimum distance d=8. First terms of the first enumerator polynomial of the Golay code are: A(X,z)=1+X⁸(12z+60z²+180z³+255z⁴+180z⁵+60z⁶+12z⁷)+X¹² (6z²+40z³+240z⁴+600z⁵+804z⁶+600z⁷+240z⁸+40z⁹+6z¹⁰)+X¹⁶(12z⁵+60z⁶+180z⁷+255z⁸+180z⁹+60z¹⁰+12z¹¹)+X²⁴z¹².

In a third example, the binary code CB is a parity code of length n containing l=n−1 payload information bits and having a minimum distance d=2. In such a code, the parity bit is a “1” only if the weight of the n−1 payload information bits is odd. The first and second enumerator polynomials of the parity code are as follows, where C is the combination operator:

$$A ( X , z ) = 1 + {\sum }_{i = 2 , 4 , 6 , K} \{ {C}_{n - 1}^{i} {z}^{i} + {C}_{n - 1}^{i - 1} {z}^{i - 1} \} {X}^{i}$$

$$and$$

$$B ( X ) = {\sum }_{i = 2 , 4 , 6 , K} \{ i {C}_{n - 1}^{i} + ( i - 1 ) {C}_{n - 1}^{i - 1} \} {X}^{i}$$

As explained above, each photoreceiver RECₖ receives a signal-to-noise ratio SNRₖ that depends on the associated light source SLₖ. Each light source SLₖ sends a bit sequence optionally SCₖ coded by a binary code CBₖ with a minimum distance dₖ. When a photoreceiver RECₖ receives a signal modulated by OOK type modulation that contains a bit sequence SCₖ coded by a code CBₖ with a minimum distance dₖ, a bit error rate BERₖ can be estimated after decoding the received signal in the following manner:

$${BER}_{k} \approx \frac{1}{{l}_{k}} {\sum }_{i = {d}_{k}}^{n} {B}_{i} \times Q ( \sqrt{i \times {SNR}_{k}} )$$

where lₖ is the dimension of the code concerned and Q(x) is the following error function:

$$Q ( x ) = \frac{1}{\sqrt{2 π}} {\int }_{x}^{∞} exp ( - \frac{{t}^{2}}{2} ) d t$$

For example, for a BCH code with a minimum distance d=5, the dimension of the code has the value l=21.

Because the error function Q(x) decreases exponentially, the bit error rate BERₖ can be approximated as a function of the first term of the sum, i.e.:

$${BER}_{k} \approx \frac{1}{{l}_{k}} {B}_{{d}_{k}} \times Q ( \sqrt{{d}_{k} \times {SNR}_{k}} )$$

According to the invention, coded bit sequences SEₖ can be coded by respective codes CBₖ with minimum distances dₖ so that the different bit error rates BERₖ that correspond to the signals comprising the respective coded bit sequences SCₖ emitted by the respective light sources SLₖ are close to one another and where applicable close to the bit error rate corresponding to the signal comprising an uncoded bit sequence emitted by the light source having the lowest signal-to-noise ratio.

For example, a coded bit sequence SCₖ is to be emitted by the light source SLₖ having the lowest signal-to-noise ratio SNRₖ of the various light sources and the bit sequence SCₖ is coded by a code with a minimum distance dₖ so that the product of the lowest signal-to-noise ratio SNRₖ by the minimum distance dₖ of the code is substantially equal to the highest signal-to-noise ratio of the various light sources or at least equal to the second lowest signal-to-noise ratio of the various light sources. In all these situations, the light source having the highest signal-to-noise ratio emits a bit sequence SBₖ that is not coded.

Referring to FIG. 2, the method of the invention of emitting signals using white light comprises steps E1 to E3 executed automatically in the emission device SE.

In the step E1, the emission device SE receives at its input a series SER of bits to be emitted by the light sources SLₖ. The serial-parallel converter CSP divides the series SER of bits into K bit sequences SB₁ to SBₖ at the rate of one bit per light source from the successive K bits of the series SER. The K bit sequences SB₁ to SBₖ are supplied to the coder COD so that they are emitted by the K light sources SL₁ to SL_{K}, respectively.

In the step E2, the coder COD codes one or more bit sequences SBₖ into coded bit sequences SCₖ to be emitted by respective light sources having the lowest signal-to-noise ratios of the various light sources. In a complementary way, the coder COD does not code the other bit sequence or sequences to be emitted by respective other light sources having the highest signal-to-noise ratios of the various light sources. Consequently, apart from the coded bit sequence to be emitted by the light source having the lowest signal-to-noise ratio, other bit sequences can be coded if they are to be emitted by other light sources having signal-to-noise ratios lying strictly between the lowest signal-to-noise ratio and the highest signal-to-noise ratio.

In an embodiment of the invention with three light sources SL₁, SL₂, and SL₃ that respectively emit blue, green, and red light, only the light source SL₁ that has a signal-to-noise ratio much higher than the other light sources SL₂ and SL₃ emits a bit sequence SB₁ that is not coded, whereas the other light sources SL₂ and SL₃ emit respective coded bit sequences SC₂ and SC₃.

As indicated above, the light source SL₁ emitting blue light has the highest signal-to-noise ratio SNR₁. The bit sequences SB₂ and SB₃ are coded into bit sequences SC₂ and SC₃, respectively, by a code CB₂ having a minimum distance d₂ and a code CB₃ having a minimum distance d₃, respectively. Each code CB₂, CB₃ is selected so that the product of the signal-to-noise ratio SNR₂, SNR₃ by the minimum distance d₂, d₃ of the code is substantially equal to the signal-to-noise ratio SNR₁:

SNR₁≈d₂×SNR₂≈d₃×SNR₃

For example, for a given position of the light sources SL₁, SL₂, and SL₃ relative to the photoreceivers and for an average power received by the photoreceivers of −30 dBm, the linear signal-to-noise ratios are SNR₁=19.86, SNR₂=8.6, and SNR₃=4.28 for the blue, green, and red diodes, respectively. The uncoded bit sequence SB₁ contains n₁=31 bits and thus l₁=31 payload information bits. The coded bit sequence SC₂ can be coded by a parity code CB₂ of length n₂ containing l₂=n₂−1 payload information bits and having a minimum distance d₂=2. The coded bit sequence SC₃ can be coded by a BCH code CB₃ of length n₃=31 containing l₃=21 payload information bits and having a minimum distance d₃=5.

Moreover, if each bit sequence SB₁, SC₂, SC₃ to be emitted contains n₁=n₂=n₃=31 bits, the overall yield ρ of the emission of the bit sequences is:

ρ=(l₁+l₂+l₃)/(3×n₁)

i.e.

ρ=(31+30+21)/(3×31)=88%.

In another example, the uncoded bit sequence SB₁ contains n₁=24 bits and thus l₁=24 payload information bits. The coded bit sequence SC₂ can be coded by a parity code CB₂ of length nₗ containing l₂=n₁−1=23 payload information bits and having a minimum distance d₂=2. The coded bit sequence SC₃ can be coded by a Golay code CB₃ of length n₁ containing l₃=12 payload information bits and having a minimum distance d₃=8. The overall yield ρ of the emission of the bit sequences is then:

ρ=(24+23+12)/(3×24)=82%

Compared to using a BCH code, using a Golay code offers a high correction capacity but results in a lower overall emission efficiency.

Alternatively, if the light sources SL₁ and SL₂ have close respective signal-to-noise ratios SNR₁ and SNR₂, the corresponding bit sequences SB₁ and SB₂ are not coded and only the bit sequence SB₃ is coded.

In the step E3, the coder COD supplies the coded or uncoded bit sequences to the respective light sources. The light source SL₁ emits the uncoded bit sequence SB₁ and the light sources SL₂ and SL₃ emit the coded bit sequences SB₂ and SB₃, respectively.

For example, a forward-biased P-N junction of each light source emits the bit sequence in the form of monochromatic radiation after OOK type intensity modulation is applied to the bit sequence.

The emission of the bit sequences by a plurality of light sources reduces the bit rate for each light source, which helps to improve correction of intersymbol interference when receiving bit sequences.

The invention described here relates to a method and a device for emitting bit sequences. In one embodiment, the steps of the method of the invention are determined by instructions of a computer program incorporated in a device such as the emission device SE. The program includes program instructions that execute the steps of the method of the invention when said program is executed in a processor of the device, the operation of which is then controlled by the execution of the program.

Consequently, the invention applies also to a computer program adapted to implement the invention, particularly a computer program stored on or in a storage medium readable by a computer or any data processing device. This program can use any programming language and take the form of source code, object code or a code intermediate between source code and object code, such as a partially-compiled form, or any other desirable form for implementing the method of the invention.

The storage medium can be any entity or device capable of storing the program. For example, the medium can include storage means in which the computer program of the invention is stored, such as a ROM, for example a CD ROM, a micro-electronic circuit ROM or a USB key, or magnetic storage means, for example a floppy disk or a hard disk.

Moreover, the storage medium can be a transmissible medium such as an electrical or optical signal, which can be routed via an electrical or optical cable, by radio or by other means. The program of the invention can in particular be downloaded over an Internet-type network.

Alternatively, the storage medium can be an integrated circuit in which the program is incorporated, the circuit being adapted to execute the method of the invention or to be used in its execution.

1. A method of emitting respective bit sequences from at least two light sources that emit radiation combined into substantially white light and that have different signal-to-noise ratios depending on the respective wavelengths of the radiation;
the method comprising coding the bit sequence to be emitted by the light source having the lowest signal-to-noise ratio by a code having a minimum distance the product of which by the lowest signal-to-noise ratio is substantially equal to the highest signal-to-noise ratio, the minimum distance of the code being equal to the minimum number of bits that differ between two words of the code.

2. The method according to claim 1, further comprising coding at least one other bit sequence to be emitted by a light source having another signal-to-noise ratio between the lowest signal-to-noise ratio and the highest signal-to-noise ratio inclusive by another code having a minimum distance the product of which by said other signal-to-noise ratio is substantially equal to the highest signal-to-noise ratio.

3. A device for emitting respective bit sequences from at least two light sources that emit radiation combined into substantially white light and that have different signal-to-noise ratios depending on the respective wavelengths of the radiation;
the device comprising a coder for coding the bit sequence to be emitted by the light source having the lowest signal-to-noise ratio by a code having a minimum distance the product of which by the lowest signal-to-noise ratio is substantially equal to the highest signal-to-noise ratio, the minimum distance of the code being equal to the minimum number of bits that differ between two words of the code.

4. The device according to claim 3, wherein the light sources are light-emitting diodes.

5. The device according to claim 3, comprising three light sources adapted to emit substantially blue, green, and red light, respectively.

6. A computer program adapted to be executed in a device for emitting respective bit sequences from at least two light sources that emit radiation combined into substantially white light and that have different signal-to-noise ratios depending on the respective wavelengths of the radiation;
said program comprising instructions which, when the program is executed in said photoreceiver, code the bit sequence to be emitted by the light source having the lowest signal-to-noise ratio by a code having a minimum distance the product of which by the lowest signal-to-noise ratio is substantially equal to the highest signal-to-noise ratio, the minimum distance of the code being equal to the minimum number of bits that differ between two words of the code.

7. A storage medium readable by a device for emitting respective bit sequences from at least two light sources that emit radiation combined into substantially white light and that have different signal-to-noise ratios depending on the respective wavelengths of the radiation;
the medium storing a computer program comprising instructions for coding the bit sequence to be emitted by the light source having the lowest signal-to-noise ratio by a code having a minimum distance the product of which by the lowest signal-to-noise ratio is substantially equal to the highest signal-to-noise ratio, the minimum distance of the code being equal to the minimum number of bits that differ between two words of the code.
